(19) United States
(12) Patent Application Publication
(10) Pub. No.: US 2023/0100612 A1
(43) Pub. Date: Mar. 30, 2023

(54) CLOUD-BASED ARTIFICIAL INTELLIGENCE LEARNING LOGISTICS MANAGEMENT SYSTEM AND METHOD

(71) Applicant: ST.corporation, Daejeon (KR)

(72) Inventors: ChangHoon JUNG, Daejeon (KR); SungSu CHOI, Daejeon (KR); HoonIl CHOI, Cheongju-si (KR)

(21) Appl. No.: 17/490,185

(22) Filed: Sep. 30, 2021

(30) Foreign Application Priority Data
Sep. 24, 2021 (KR) 10-2021-0126132

(51) Int. Cl. G06Q 10/08; G06K 9/62; G06N 3/10

(52) U.S. Cl. CPC G06Q 10/087; G06K 9/6267; G06N 3/10

(57) ABSTRACT

Disclosed herein is a cloud-based artificial intelligence learning logistics management system including: a management server connected to a communication network, and configured to perform overall logistics management; an autonomous transfer robot terminal configured to connect and communicate with a first terminal processing unit of the management server over the communication network; an operator terminal configured to connect and communicate with a second terminal processing unit of the management server over the communication network; a warehouse management terminal configured to connect and communicate with a third terminal processing unit of the management server over the communication network; a database server connected to a first server processing unit of the management server, and configured to manage a database; and an artificial intelligence learning server connected to a second server processing unit of the management server, and configured to generate and store a deep learning solution.

### CROSS-REFERENCE TO RELATED APPLICATION

This application claims priority to Korean Patent Application No. 10-2021-0126132 filed on Sep. 24, 2021, which application is incorporated herein by reference in its entirety.

### BACKGROUND

### 1. Technical Field

The present invention relates generally to a cloud-based artificial intelligence learning logistics management system and method, and more particularly to a cloud-based artificial intelligence learning logistics management system and method in which data is collected from an autonomous transfer robot, an operator, a logistics warehouse, and the World Wide Web (the Internet), a deep learning solution is generated through artificial intelligence self-learning, and the demand for products is predicted, lines of movement of the autonomous transfer robot are optimized and the safety of the operator is ensured during operation by using the deep learning solution.

### 2. Description of the Related Art

Deep learning (also called deep structured learning or hierarchical learning) is defined as a set of machine learning algorithms that attempt high-level abstraction (the task of summarizing key contents or functions in large amounts of data or complex materials) through a combination of various nonlinear transformation techniques. Broadly speaking, it can be said that it is a branch of machine learning that teaches computers people's way of thinking.

Deep learning has exhibited the highest level of performance in various fields, especially automatic speech recognition (ASR) and computer vision. These approaches have usually used databases generated for continuous improvement in the performance of new applications of deep learning, such as TIMIT (a sound database produced by Texas Instruments and MIT), and MNIST (a hand-written numeric image database for image clustering produced by the National Institute of Standards and Technology). Recently, deep learning algorithms based on convolutional neural networks have exhibited excellent performance, especially in fields such as computer vision and speech recognition.

Damage occurs when the warehousing and shipping of products in and from a logistics warehouse cannot be managed. Accordingly, there has increased the need for a method that can effectively use a warehouse by predicting the quantity of products stored in and shipped from the warehouse.

As the robot industry develops in line with the development of the production technology of modern industrial society, robots have replaced human labor and the field of application thereof has gradually expanded. However, as the demand for industrial robots increases, the number of victims is also increasing. As safety devices for industrial robots, isolated protective measures, sensitive protective devices, and emergency stop devices are installed to prevent any part of an operator's body from approaching all dangerous points of industrial robots. In the case of logistics robots, there are limitations in terms of these safety devices. Therefore, there is a need for the development of additional technology capable of overcoming this problem.

### RELATED ART DOCUMENTS

Patent document 1: KR 10-2021-0084025 A
Patent document 2: KR 10-2212589 B1
Patent document 3: KR 10-2018-0068002 A

### SUMMARY

The present invention has been conceived to overcome the above-described problems, and an object of the present invention is to generate a deep learning solution through artificial intelligence self-learning by using data from an autonomous transfer robot, an operator, a logistics warehouse, and the World Wide Web (the Internet), and to predict the demand for products to order to minimize warehouse costs, optimize lines of movement of the autonomous transfer robot, and ensure the safety of the operator during operation by using the deep learning solution.

In order to accomplish the above object, the present invention provides a cloud-based artificial intelligence learning logistics management system including: a management server connected to a communication network, and configured to perform overall logistics management; an autonomous transfer robot terminal configured to connect and communicate with a first terminal processing unit of the management server over the communication network; an operator terminal configured to connect and communicate with a second terminal processing unit of the management server over the communication network; a warehouse management terminal configured to connect and communicate with a third terminal processing unit of the management server over the communication network; a database server connected to a first server processing unit of the management server, and configured to manage a database; and an artificial intelligence learning server connected to a second server processing unit of the management server, and configured to generate and store a deep learning solution.

The management server may include: the first terminal processing unit configured to connect and communicate with the autonomous transfer robot terminal over the communication network; the second terminal processing unit configured to connect and communicate with the operator terminal over the communication network; the third terminal processing unit configured to connect and communicate with the warehouse management terminal over the communication network; the first server processing unit configured to connect and communicate with the database server; and the second server processing unit configured to connect and communicate with the artificial intelligence learning server.

The first terminal processing unit may receive generated image, sound and absolute location data from the autonomous transfer robot terminal, and may transmit the deep learning solution, generated by the artificial intelligence learning server, to the autonomous transfer robot terminal.

The second terminal processing unit may receive generated image, sound and absolute location data from the operator terminal, and may transmit the deep learning solution, generated by the artificial intelligence learning server, to the operator terminal.

The third terminal processing unit may receive generated image, sound and absolute location data from the warehouse management terminal, and may transmit the deep learning solution, generated by the artificial intelligence learning server, to the warehouse management terminal.

The first server processing unit may transmit the image, sound and absolute location data, received from the autonomous transfer robot terminal, the operator terminal, and the warehouse management terminal, to the database server, and, when the artificial intelligence learning server collects data for learning, may receive the data for learning to the management server in order to transmit the data stored in the database server to the artificial intelligence learning server.

The second server processing unit may transmit the data, stored in the database server, for the collection of the data for learning, and may receive the deep learning solution, generated by the artificial intelligence learning server, to the management server.

The database server may include: a first server collection unit configured to connect and communicate with the first server processing unit of the management server, to receive generated image, sound, absolute location data from the autonomous transfer robot terminal, the operator terminal, and the warehouse management terminal through the first server processing unit, and to collect data present on a World Wide Web (an Internet); a first server analysis unit configured to determine availability of data collected by the first server collection unit; a first server classification unit configured to classify the data, determined by the first server analysis unit, by category; and a first server storage unit configured to store the data classified by the first server classification unit.

The artificial intelligence learning server may include: a second server collection unit configured to connect and communicate with the second server processing unit of the management server, and to collect data stored in the first server storage unit of the database server as data for learning through the management server; a second server storage unit configured to store the data for learning collected through the second server collection unit; a self-learning unit configured to generate the deep learning solution based on self-learning data and domain ontology provided from an outside by using the data stored in the second server storage unit; and a deep learning solution storage unit configured to store the deep learning solution, generated by the self-learning unit, by category.

The autonomous transfer robot terminal may include: a first terminal detection unit including a first photographing unit installed in the autonomous transfer robot terminal and configured to photograph image data, a first recording unit configured to record sound data, and a first location tracking unit configured to have a GPS sensor that detects absolute location data, and configured to transmit the detected data to a first terminal execution unit, and to transmit the detected data to the management server through the first terminal processing unit, so that the management server transmits the detected data to the first server collection unit through the first server processing unit; a first terminal storage unit configured to store the deep learning solution transmitted to the autonomous transfer robot terminal; and a first terminal execution unit configured to perform operation while optimizing lines of movement by controlling the autonomous transfer robot using the deep learning solution stored in the first terminal storage unit based on the data transmitted from the first terminal detection unit and to ensure safety of an operator by preventing the autonomous transfer robot from colliding with the operator.

The operator terminal may include: a second terminal detection unit including a second photographing unit installed in the operator terminal and configured to photograph image data, a second recording unit configured to record sound data, and a second location tracking unit configured to have a GPS sensor that detects absolute location data, and configured to transmit the detected data to the second terminal execution unit, and to transmit the detected data to the management server through the second terminal processing unit, so that the management server transmits the detected data to the first server collection unit through the first server processing unit; a second terminal storage unit configured to store the deep learning solution transmitted to the operator terminal; and a second terminal execution unit including a speaker unit configured to receive sound data and output information and a display unit configured to receive image data and output information, and configured to provide an efficient operation sequence to the operator by using the deep learning solution stored in the second terminal storage unit based on the data transmitted from the second terminal detection unit and to ensure safety of the operator by warning of a risk during operation.

The warehouse management terminal may include: a third terminal detection unit including a third recording unit installed in the warehouse management terminal and configured to photograph image data and a third recording unit configured to record sound data, and configured to transmit the detected data to the third terminal execution unit and to transmit the detected data to the management server through the third terminal processing unit, so that the management server transmits the detected data to the first server collection unit through the first server processing unit; a third terminal storage unit configured to store the deep learning solution transmitted to the warehouse management terminal; and a third terminal execution unit configured to collect data related to management of the logistics warehouse from the data stored by category after being processed by category in the third terminal detecting unit and the first server storage unit, and then to analyze inventory of the warehouse using the collected data and a demand prediction model of the deep learning solution stored in the third terminal storage unit.

The display unit may transfer data to the operator through an augmented reality interface by means of a transmissive display using organic light emitting diodes (OLEDs).

The cloud-based artificial intelligence learning logistics management system may form a distributed cloud that transmits the deep learning solution, generated by the self-learning unit, to the autonomous transfer robot terminal, the operator terminal, and the warehouse management terminal so that processing is performed therein.

The communication network may be any one communication network formed by combining one or more selected from the group consisting of an Internet, a Bluetooth network, a Wi-Fi network, and an Internet of Things (IoT).

The deep learning solution may include a demand prediction model configured to predict a demand for warehouse products, a movement route optimization model for the autonomous transfer robot, and an operation optimization model for the operator that are generated through the self-learning unit by using autonomous transfer robot-generated data including an absolute location, route, motion, image, and sound of the autonomous transfer robot, operator-generated data including an absolute location, route, motion, image, and sound of the operator, unique product data including a producer, size, weight and quantity of the products in a warehouse, historical sales statistics of the products, product transportation data, surrounding event data, and demand data related to weather and temperature, which are data for learning refined through the first server collection unit, the first server analysis unit, the first server classification unit, and the first server storage unit.

According to another aspect of the present invention, there is provided a cloud-based artificial intelligence learning logistics management method including: a data collection step of collecting, by a first server collection unit, data; a data analysis step of analyzing availability of the data collected at the data collection step; a data classification step of classifying the data, analyzed at the data analysis step, by category; a data storage step of storing the data processed at the data processing step; a data-for-learning collection step of collecting the data, stored at the data storage step, as data for learning; a data-for-learning storage step of storing the data for learning collected at the data-for-learning collection step; a self-learning step of generating a deep learning solution based on self-learning data and domain ontology provided from an outside by using the data stored at the data-for-learning storage step; a deep learning solution storage step of storing the deep learning solution generated at the self-learning step; a deep learning solution transmission step of transmitting the deep learning solution, stored at the deep learning solution storage step, to an autonomous transfer robot terminal, an operator terminal, and a warehouse management terminal; and a deep learning solution-based processing step of performing logistics management by using the deep learning solution received by the autonomous transfer robot terminal, the operator terminal, and the warehouse management terminal.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a configuration diagram showing a cloud-based artificial intelligence learning logistics management system according to an embodiment of the present invention;

FIG. 2 is a detailed block diagram showing the management server of the cloud-based artificial intelligence learning logistics management system according to the embodiment of the present invention;

FIG. 3 is a detailed block diagram showing the database server of the cloud-based artificial intelligence learning logistics management system according to the embodiment of the present invention;

FIG. 4 is a detailed block diagram showing the artificial intelligence learning server of the cloud-based artificial intelligence learning logistics management system according to the embodiment of the present invention;

FIG. 5 is a detailed block diagram showing the autonomous transfer robot terminal of the cloud-based artificial intelligence learning logistics management system according to the embodiment of the present invention;

FIG. 6 is a detailed block diagram showing the operator terminal of the cloud-based artificial intelligence learning logistics management system according to the embodiment of the present invention;

FIG. 7 is a detailed block diagram showing the warehouse management terminal of the cloud-based artificial intelligence learning logistics management system according to the embodiment of the present invention;

FIG. 8 is a block diagram showing a cloud-based artificial intelligence learning logistics management system according to the embodiment of the present invention; and

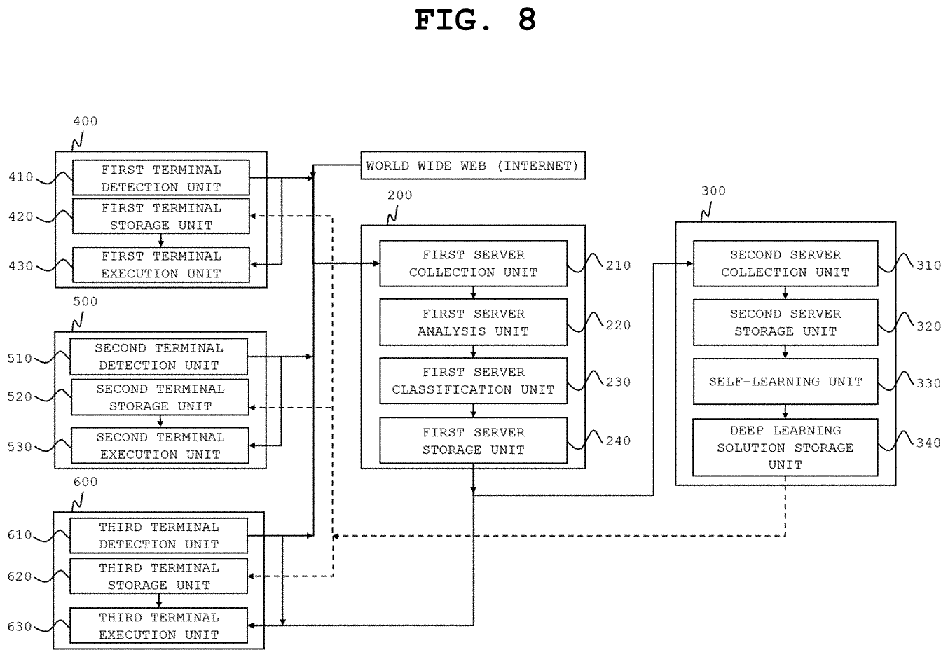

FIG. 9 is a flowchart showing a cloud-based artificial intelligence learning logistics management method according to an embodiment of the present invention.

### DETAILED DESCRIPTION

Embodiments of the present invention will be described in detail below with reference to the accompanying drawings so that a person of ordinary skill in the art to which the present invention pertains can easily implement the technical spirit of the present invention.

However, the following embodiments are merely examples intended to help the understanding of the present invention, and do not reduce or limit the scope of the present invention. Furthermore, the present invention may be embodied in various different forms and is not limited to the embodiments described herein.

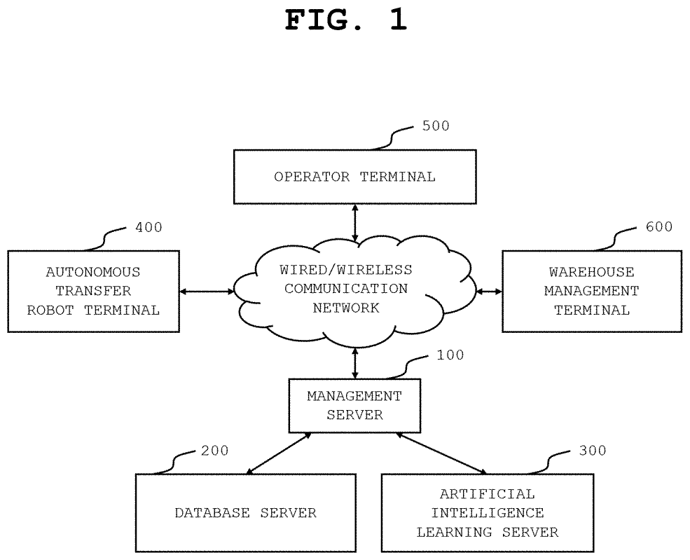

FIG. 1 is a configuration diagram showing a cloud-based artificial intelligence learning logistics management system according to an embodiment of the present invention.

Referring to FIG. 1, the cloud-based artificial intelligence learning logistics management system according to the present embodiment includes a management server 100 connected to a communication network, a database server 200, an artificial intelligence learning server 300, an autonomous transfer robot terminal 400, an operator terminal 500, and a warehouse management terminal 600.

In this case, the communication network may be any one communication network formed by combining one or more selected from the group consisting of the Internet, a Bluetooth network, a Wi-Fi network, and the Internet of Things (IoT).

The management server 100 is a server that is connected to the communication network and manages the overall operation or process of the cloud-based artificial intelligence learning logistics management system and method.

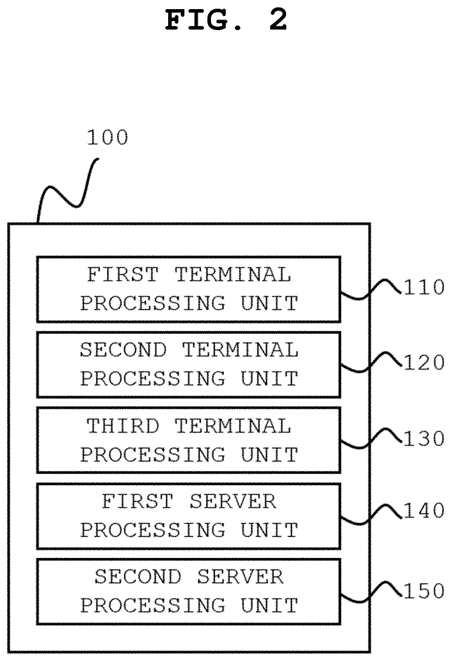

FIG. 2 is a detailed block diagram showing the management server 100 of the cloud-based artificial intelligence learning logistics management system according to the embodiment of the present invention.

Referring to FIG. 2, the management server 100 may include a first terminal processing unit 110, a second terminal processing unit 120, a third terminal processing unit 130, a first server processing unit 140, and a second server processing unit 150.

The first terminal processing unit 110 receives generated image, sound and absolute location data from the autonomous transfer robot terminal 400, and transmits a deep learning solution, generated by the artificial intelligence learning server 300, to the autonomous transfer robot terminal 400.

The second terminal processing unit 120 receives generated image, sound and absolute location data from the operator terminal 500, and transmits the deep learning solution, generated by the artificial intelligence learning server 300, to the operator terminal 500.

The third terminal processing unit 130 receives generated image, sound and absolute location data from the warehouse management terminal 600, and transmits the deep learning solution, generated by the artificial intelligence learning server 300, to the warehouse management terminal 600.

The first server processing unit 140 transmits the image, sound and absolute location data, received from the autonomous transfer robot terminal 400, the operator terminal 500, and the warehouse management terminal 600, to the database server 200. When the artificial intelligence learning server 300 collects data for learning, the data for learning is received by the management server 100 in order to transmit the data, stored in the database server 200, to the artificial intelligence learning server 300.

The second server processing unit 150 transmits the data, stored in the database server 200, in order to collect the data for learning, and the deep learning solution generated by the artificial intelligence learning server 300 is received by the management server 100.

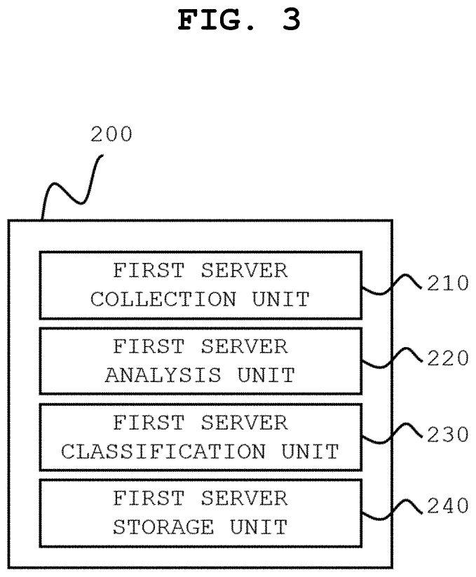

FIG. 3 is a detailed block diagram showing the database server 200 of the cloud-based artificial intelligence learning logistics management system according to the embodiment of the present invention.

Referring to FIG. 3, the database server 200 may include a first server collection unit 210, a first server analysis unit 220, a first server classification unit 230, and a first server storage unit 240.

The first server collection unit 210 connects and communicates with the first server processing unit 140 of the management server 100, receives generated image, sound and absolute location data from the autonomous transfer robot terminal 400, the operator terminal 500, and the warehouse management terminal 600 through the first server processing unit 140, collects data present on the World Wide Web (the Internet), and transmits the collected data to the first server analysis unit 220.

The first server analysis unit 220 determines the availability of the data collected by the first server collection unit 210, and transmits the data to the first server classification unit 230.

The first server classification unit 230 classifies and refines the data, determined by the first server analysis unit, by category, and then transmits the data to the first server storage unit 240.

The first server storage unit 240 stores the data classified and refined by the first server classifying unit, and transmits the classified and refined data in the artificial intelligence learning server 300 through the management server 100.

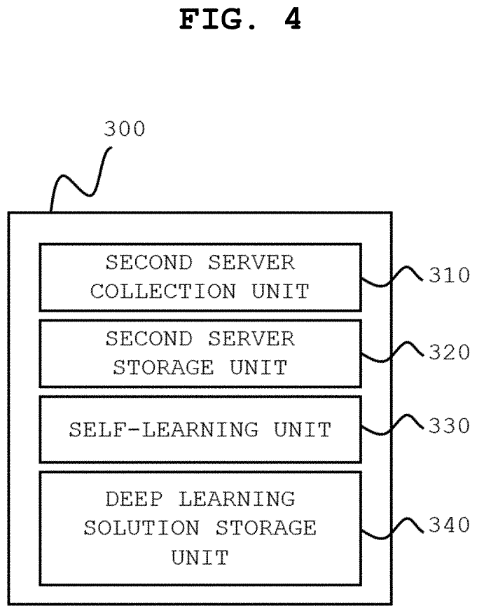

FIG. 4 is a detailed block diagram showing the artificial intelligence learning server 300 of the cloud-based artificial intelligence learning logistics management system according to the embodiment of the present invention.

Referring to FIG. 4, the artificial intelligence learning server 300 may include a second server collection unit 310, a second server storage unit 320, a self-learning unit 330, and a deep learning solution storage unit 340.

The second server collection unit 310 connects and communicates with the second server processing unit 150 of the management server 100, and collects the data, stored in the first server storage unit 140 of the database server 200, as data for the learning through the management server 100.

The second server storage unit 320 stores the data for learning collected through the second server collection unit 310.

The self-learning unit 330 generates a deep learning solution based on self-learning data and domain ontology provided from the outside by using the data stored in the second server storage unit 320.

The domain ontology is the ontology constructed for valid knowledge in a specific area, and is a collection of concepts in each of which a semantic relationship is constructed in a limited area such as a specific object or a specific academic area.

The deep learning solution storage unit 340 stores the deep learning solution, generated by the self-learning unit 330, by category.

The deep learning solution may include a demand prediction model configured to predict a demand for warehouse products, a movement route optimization model for the autonomous transfer robot, and an operation optimization model for the operator that are generated through the self-learning unit 330 by using autonomous transfer robot-generated data including the absolute location, route, motion, image, and sound of the autonomous transfer robot, operator-generated data including the absolute location, route, motion, image, and sound of the operator, unique product data including the producer, size, weight and quantity of products in the warehouse, the historical sales statistics of the products, product transportation data, surrounding event data, and demand data related to weather and temperature, which are the data for learning refined through the first server collection unit 210, the first server analysis unit 220, the first server classification unit 230, and the first server storage unit 240.

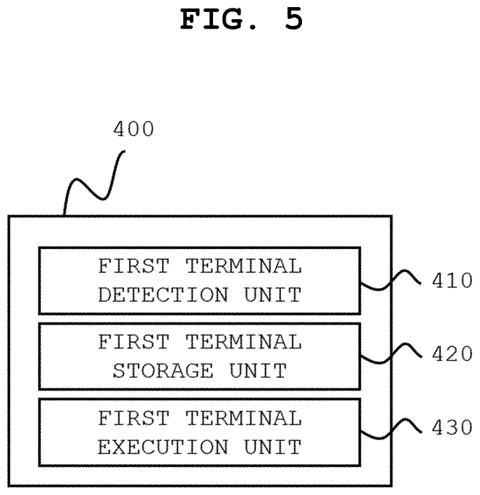

FIG. 5 is a detailed block diagram showing the autonomous transfer robot terminal 400 of the cloud-based artificial intelligence learning logistics management system according to the embodiment of the present invention.

Referring to FIG. 5, the autonomous transfer robot terminal 400 may include a first terminal detection unit 410, a first terminal storage unit 420, and a first terminal execution unit 430.

The first terminal detection unit 410 includes a first photographing unit installed in the autonomous transfer robot terminal 400 and configured to photograph image data, a first recording unit configured to record sound data, and a first location tracking unit configured to have a GPS sensor that detects absolute location data. The first terminal detecting unit 410 transmits the detected data to the first terminal execution unit 430, and transmits the detected data to the management server 100 through the first terminal processing unit 110, so that the management server 100 transmits the detected data to the first server collection unit 210 through the first server processing unit 140.

The first terminal storage unit 420 stores the deep learning solution transmitted to the autonomous transfer robot terminal.

The first terminal execution unit 430 performs operation while optimizing lines of movement by controlling the autonomous transfer robot using the deep learning solution stored in the first terminal storage unit 420 based on the data transmitted from the first terminal detection unit 410, and ensures the safety of the operator by preventing the autonomous transfer robot from colliding with the operator.

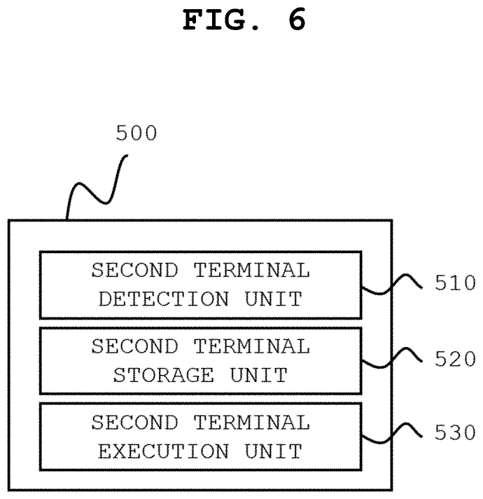

FIG. 6 is a detailed block diagram showing the operator terminal 500 of the cloud-based artificial intelligence learning logistics management system according to the embodiment of the present invention.

Referring to FIG. 6, the operator terminal 500 may include a second terminal detection unit 510, a second terminal storage unit 520, and a second terminal execution unit 530.

The second terminal detection unit 510 includes a second photographing unit installed in the operator terminal 500 and configured to photograph image data, a second recording unit configured to record sound data, and a second location tracking unit configured to have a GPS sensor that detects absolute location data. The second terminal detection unit 510 transmits the detected data to the second terminal execution unit 530, and transmits the detected data to the management server 100 through the second terminal processing unit 120, so that the management server 100 transmits the detected data to the first server collection unit 210 through the first server processing unit 140.

The second terminal storage unit 520 stores the deep learning solution transmitted to the operator terminal 500.

The second terminal execution unit 530 includes a speaker unit configured to receive sound data and output information, and a display unit configured to receive image data and output information. The second terminal execution unit 530 provides an efficient operation sequence to the operator by using the deep learning solution stored in the second terminal storage unit 520 based on the data transmitted from the second terminal detection unit 510, and ensures the safety of the operator by warning of a risk during operation.

The display unit transfers data to the operator through an augmented reality interface by means of a transmissive display using organic light emitting diodes (OLEDs).

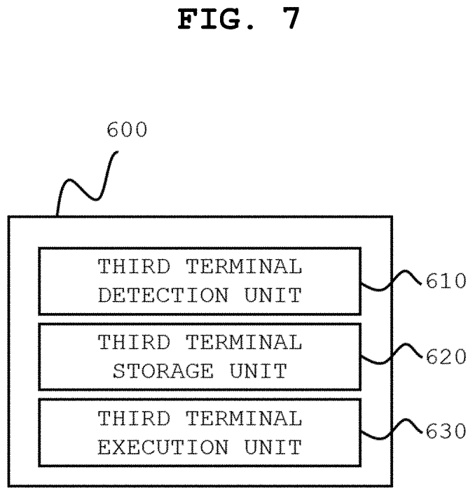

FIG. 7 is a detailed block diagram showing the warehouse management terminal 600 of the cloud-based artificial intelligence learning logistics management system according to the embodiment of the present invention.

Referring to FIG. 7, the warehouse management terminal 600 may include a third terminal detection unit 610, a third terminal storage unit 620, and a third terminal execution unit 630.

The third terminal detection unit 610 includes a third recording unit installed in the warehouse management terminal 600 and configured to photograph image data, and a third recording unit configured to record sound data. The third terminal detection unit 610 transmits the detected data to the third terminal execution unit 630, and transmits the detected data to the management server 100 through the third terminal processing unit 130, so that the management server 100 transmits the detected data to the first server collection unit 210 through the first server processing unit 110.

The third terminal storage unit 620 stores the deep learning solution transmitted to the warehouse management terminal 600.

The third terminal execution unit 630 collects data related to the management of the logistics warehouse from the data stored by category after being processed by category in the third terminal detecting unit 610 and the first server storage unit 240, and then analyzes the inventory of the warehouse using the collected data and the demand prediction model of the deep learning solution stored in the third terminal storage unit 620.

The cloud-based artificial intelligence learning logistics management system forms a distributed cloud that transmits the deep learning solution, generated by the self-learning unit, to the autonomous transfer robot terminal, the operator terminal, and the warehouse management terminal so that processing is performed therein.

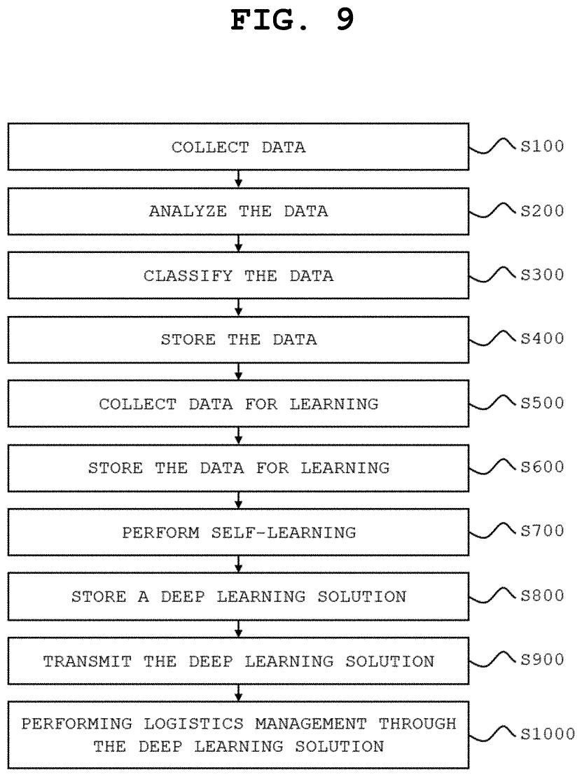

FIG. 9 is a flowchart showing a cloud-based artificial intelligence learning logistics management method according to an embodiment of the present invention.

Referring to FIG. 9, the cloud-based artificial intelligence learning logistics management method according to the present embodiment may include a data collection step S100, a data analysis step S200, a data classification step S300, a data storage step S400, a data-for-learning collection step S500, a data-for-learning storage step S600, a self-learning step S700, a deep learning solution storage step S800, a deep learning solution transmission step S900, and a deep learning solution-based processing step S1000.

The data collection step S100 is the step at which the first collection unit 210 collects generated image, sound and absolute location data from the autonomous transfer robot terminal 400, the operator terminal 500, and the warehouse management terminal 600 and also collects data present on the World Wide Web (the Internet).

The data analysis step S200 is the step of determining whether the data generated through the data collection step S100 is suitable for use in logistics management by the first server analysis unit 220.

The data classification step S300 is the step of classifying the data, determined to be suitable for use in logistics management at the data analysis step S200, into one of the categories including autonomous transfer robot-generated data including the absolute location, route, motion, image, and sound of the autonomous transfer robot, operator-generated data including the absolute location, route, motion, image, and sound of the operator, unique product data including the producer, size, weight and quantity of products in the warehouse, the historical sales statistics of the products, product transportation data, surrounding event data, and demand data related to weather and temperature.

The data storage step S400 is the step of storing the refined data, classified into the categories at the data classification step S300, by category.

The data-for-learning collection step S500 is the step of collecting the refined data stored in the first server storage unit 240 through the data storage step S400 of storing the data for self-learning in the artificial intelligence learning server 300.

The data-for-learning storage step S600 is the step of storing the data for learning, collected at the data-for-learning collection step S500, in the artificial intelligence learning server 300.

The self-learning step S700 is the step of generating a deep learning solution based on self-learning data and domain ontology provided from the outside by using the data for learning stored in the artificial intelligence learning server 300.

The deep learning solution includes a demand prediction model configured to predict a demand for warehouse products, a movement route optimization model for the autonomous transfer robot, and an operation optimization model for the operator that are generated through the self-learning unit 330 by using autonomous transfer robot-generated data including the absolute location, route, motion, image, and sound of the autonomous transfer robot, operator-generated data including the absolute location, route, motion, image, and sound of the operator, unique product data including the producer, size, weight and quantity of products in the warehouse, the historical sales statistics of the products, product transportation data, surrounding event data, and demand data related to weather and temperature, which are the data for learning refined through the first server collection unit 210, the first server analysis unit 220, the first server classification unit 230, and the first server storage unit 240.

The deep learning solution is transmitted to and stored in each of the terminals. The autonomous transfer robot terminal 400 determines the locations of products in a warehouse, determines a sequence and routes for the transfer of the products, and selects an optimal route, thereby increasing the efficiency of an operation, prevents collisions between the autonomous transfer robot and the operator between operations, and transmits a danger signal to the operator terminal 500. The operator terminal 500 provides an efficient operation sequence by using the stored deep learning solution based on the image, sound, and absolute location data generated by the second terminal detecting unit 510, warns of the risk of a collision between the operator and the autonomous transfer robot during operation, and transmits a stop signal to the autonomous transfer robot terminal 400 when it is determined that a collision has occurred, thereby ensuring the safety of the operator. The warehouse management terminal 600 collects data related to warehouse management from the image and sound data generated by the third terminal detection unit 610 and the refined data stored in the first server storage unit 240, analyzes the inventory of the warehouse by using the demand prediction model of the deep learning solution, and transfers an efficient inventory management method to the operator terminal 500.

When the deep learning solution is generated, the lowest value of a loss function is found using an Adaptive Moment Estimation (Adam) optimizer.

The Adam optimizer is currently the most widely used deep learning optimization technique, and stores the exponential average of the slopes calculated by the momentum method and the exponential average of the square values of the slopes of RMSProp.

mₜ=β₁mₜ₋₁+(1−β₁)∇_{θ}J(θ) (1)

vₜ=β₂vₜ₋₁+(1−β₂)(∇_{θ}J(θ))² (2)

In these equations, mₜ is the exponential average of the calculated slopes, and vₜ is the exponential average of the square values of the calculated slopes.

$${\hat{m}}_{t} = \frac{{m}_{t}}{1 - {β}_{1}^{t}} , {\hat{v}}_{t} = \frac{{v}_{t}}{1 - {β}_{2}^{t}} \qquad ( 3 )$$

$${θ}_{t + 1} = {θ}_{t} - \frac{η}{\sqrt{{\hat{v}}_{t}} + ε} {\hat{m}}_{t} \qquad ( 4 )$$

In these equations, \hat{m}ₜ and \hat{v}ₜ are correction values that make mₜ and vₜ unbiased because m and v are initialized to 0, and thus it is determined that mₜ and vₜ may be biased close to 0 at the beginning of learning.

In these equations, β₁ is 0.9, β₂ is 0.999, and ε is 10⁻⁸.

The deep learning solution storage step S800 is the step of storing the deep learning solution, generated at the self-learning step S700, in the deep learning solution storage unit 340 in order to transmit it to each terminal.

The deep learning solution transmission step S900 is the step of transmitting the deep learning solution, stored in the deep learning solution storage unit 340, to each of the autonomous transfer robot terminal 400, the operator terminal 500, and the warehouse management terminal 600.

In the case where a cloud is formed on a single server, a bottleneck may occur when it is necessary to process a lot of operations in a moment, or a delay may occur when an urgent danger signal needs to be transmitted. However, the deep learning solution transmission step S900 is the step at which the cloud-based artificial intelligence learning logistics management system of the present invention forms a distributed cloud, which can overcome the problems of the conventional system.

The deep learning solution-based processing step S1000 is the step at which the autonomous transfer robot terminal 400, the operator terminal 500, and the warehouse management terminal 600 perform operations using the deep learning solution transmitted at the deep learning solution transmission step S900.

At the deep learning solution-based processing step S1000, the autonomous transfer robot terminal 400 stores the deep learning solution in the first terminal storage unit 420, determines the locations of products in the warehouse by using the stored deep learning solution based on the image, sound, and absolute location data generated by the first terminal detection unit 410, determines a sequence and routes for the transfer of the products, and selects an optimal route, thereby increasing the efficiency of an operation, prevents collisions between the autonomous transfer robot and the operator between operations, and transfers a danger signal to the operator terminal 500.

At the deep learning solution-based processing step S1000, the operator terminal 500 stores the deep learning solution in the second terminal storage unit 520, provides an efficient operation sequence by using the stored deep learning solution based on the image, sound, and absolute location data generated by the second terminal detecting unit 510, warns of the risk of a collision between the operator and the autonomous transfer robot during operation, and transmits a stop signal to the autonomous transfer robot terminal 400 when it is determined that a collision has occurred, thereby ensuring the safety of the operator.

At the deep learning solution-based processing step S1000, the warehouse management terminal 600 stores the deep learning solution in the third terminal storage unit 620, collects data related to warehouse management from the image and sound data generated by the third terminal detection unit 610 and the refined data stored in the first server storage unit 240, analyzes the inventory of the warehouse by using the demand prediction model of the deep learning solution, and transfers an efficient inventory management method to the operator terminal 500.

### Experimental Example 1: Changes in the Logistics Cost of the Warehouse to which the Deep Learning Solution is Applied

For the warehouse used in August of 2020, logistics costs were simulated for the numbers of times learning was performed by applying the above deep learning solution.

TABLE 1
Warehouse logistics cost (10,000 won)

| The number of times | 10 | 100 | 1,000 | 10,000 |
|---|---|---|---|---|
| learning was performed | | | | |
| Applied | 640 | 600 | 540 | 520 |
| Not applied | 650 | | | |
| Reduction rate % | 1.5 | 7.7 | 16.9 | 20 |

As shown in Table 1 above, the logistics cost of the warehouse could be reduced by 20% by using the deep learning solution that had performed learning 10,000 times.

As described above, the present invention has the concept of providing the cloud-based artificial intelligence learning logistics management system and method as its major technical spirit. The embodiments described above with reference to the drawings are merely examples. The true scope of the present invention is based on the attached claims, and will also extend to equivalent embodiments that may be present in various ways.

According to the cloud-based artificial intelligence learning logistics management system and method of the present invention configured as described above, the following effects can be achieved:

A deep learning solution can be generated through artificial intelligence self-learning by using data from an autonomous transfer robot, an operator, a logistics warehouse, and the World Wide Web (the Internet), and a demand for products can be predicted to minimize warehouse costs, lines of movement of the autonomous transfer robot can be optimized and the safety of the operator can be ensured during operation by using the deep learning solution.

Although the present invention has been described with reference to the embodiments shown in the accompanying drawings, this is merely exemplary, and it will be apparent to those of ordinary skill in the art that various modifications and other equivalent embodiments may be possible therefrom. Therefore, the true technical protection scope of the present invention should be defined based on the technical spirit of the appended claims.

What is claimed is:

1. A cloud-based artificial intelligence learning logistics management system comprising:
a management server connected to a communication network, and configured to perform overall logistics management;
an autonomous transfer robot terminal configured to connect and communicate with a first terminal processing unit of the management server over the communication network;
an operator terminal configured to connect and communicate with a second terminal processing unit of the management server over the communication network;
a warehouse management terminal configured to connect and communicate with a third terminal processing unit of the management server over the communication network;
a database server connected to a first server processing unit of the management server, and configured to manage a database; and
an artificial intelligence learning server connected to a second server processing unit of the management server, and configured to generate and store a deep learning solution.

2. The cloud-based artificial intelligence learning logistics management system of claim 1, wherein the management server comprises:
the first terminal processing unit configured to connect and communicate with the autonomous transfer robot terminal over the communication network;
the second terminal processing unit configured to connect and communicate with the operator terminal over the communication network;
the third terminal processing unit configured to connect and communicate with the warehouse management terminal over the communication network;
the first server processing unit configured to connect and communicate with the database server; and
the second server processing unit configured to connect and communicate with the artificial intelligence learning server.

3. The cloud-based artificial intelligence learning logistics management system of claim 2, wherein the first terminal processing unit receives generated image, sound and absolute location data from the autonomous transfer robot terminal, and transmits the deep learning solution, generated by the artificial intelligence learning server, to the autonomous transfer robot terminal,
wherein the second terminal processing unit receives generated image, sound and absolute location data from the operator terminal, and transmits the deep learning solution, generated by the artificial intelligence learning server, to the operator terminal,
wherein the third terminal processing unit receives generated image, sound and absolute location data from the warehouse management terminal, and transmits the deep learning solution, generated by the artificial intelligence learning server, to the warehouse management terminal,
wherein the first server processing unit transmits the image, sound and absolute location data, received from the autonomous transfer robot terminal, the operator terminal, and the warehouse management terminal, to the database server, and, when the artificial intelligence learning server collects data for learning, receives the data for learning to the management server in order to transmit the data stored in the database server to the artificial intelligence learning server, and
wherein the second server processing unit transmits the data, stored in the database server, for collection of the data for learning, and receives the deep learning solution, generated by the artificial intelligence learning server, to the management server.

4. The cloud-based artificial intelligence learning logistics management system of claim 1, wherein the database server comprises:
a first server collection unit configured to connect and communicate with the first server processing unit of the management server, to receive generated image, sound, absolute location data from the autonomous transfer robot terminal, the operator terminal, and the warehouse management terminal through the first server processing unit, and to collect data present on a World Wide Web (an Internet);
a first server analysis unit configured to determine availability of data collected by the first server collection unit;
a first server classification unit configured to classify the data, determined by the first server analysis unit, by category; and
a first server storage unit configured to store the data classified by the first server classification unit.

5. The cloud-based artificial intelligence learning logistics management system of claim 1, wherein the artificial intelligence learning server comprises:
a second server collection unit configured to connect and communicate with the second server processing unit of the management server, and to collect data stored in the first server storage unit of the database server as data for learning through the management server;
a second server storage unit configured to store the data for learning collected through the second server collection unit;
a self-learning unit configured to generate the deep learning solution based on self-learning data and domain ontology provided from an outside by using the data stored in the second server storage unit; and
a deep learning solution storage unit configured to store the deep learning solution, generated by the self-learning unit, by category.

6. The cloud-based artificial intelligence learning logistics management system of claim 1, wherein the autonomous transfer robot terminal comprises:
a first terminal detection unit including a first photographing unit installed in the autonomous transfer robot terminal and configured to photograph image data, a first recording unit configured to record sound data, and a first location tracking unit configured to have a GPS sensor that detects absolute location data, and configured to transmit the detected data to a first terminal execution unit, and to transmit the detected data to the management server through the first terminal processing unit, so that the management server transmits the detected data to the first server collection unit through the first server processing unit;
a first terminal storage unit configured to store the deep learning solution transmitted to the autonomous transfer robot terminal; and
a first terminal execution unit configured to perform operation while optimizing lines of movement by controlling the autonomous transfer robot using the deep learning solution stored in the first terminal storage unit based on the data transmitted from the first terminal detection unit and to ensure safety of an operator by preventing the autonomous transfer robot from colliding with the operator,
wherein the operator terminal comprises:
a second terminal detection unit including a second photographing unit installed in the operator terminal and configured to photograph image data, a second recording unit configured to record sound data, and a second location tracking unit configured to have a GPS sensor that detects absolute location data, and configured to transmit the detected data to the second terminal execution unit, and to transmit the detected data to the management server through the second terminal processing unit, so that the management server transmits the detected data to the first server collection unit through the first server processing unit;
a second terminal storage unit configured to store the deep learning solution transmitted to the operator terminal; and
a second terminal execution unit including a speaker unit configured to receive sound data and output information and a display unit configured to receive image data and output information, and configured to provide an efficient operation sequence to the operator by using the deep learning solution stored in the second terminal storage unit based on the data transmitted from the second terminal detection unit and to ensure safety of the operator by warning of a risk during operation, and
wherein the warehouse management terminal comprises:
a third terminal detection unit including a third recording unit installed in the warehouse management terminal and configured to photograph image data and a third recording unit configured to record sound data, and configured to transmit the detected data to the third terminal execution unit and to transmit the detected data to the management server through the third terminal processing unit, so that the management server transmits the detected data to the first server collection unit through the first server processing unit;
a third terminal storage unit configured to store the deep learning solution transmitted to the warehouse management terminal; and
a third terminal execution unit configured to collect data related to management of the logistics warehouse from the data stored by category after being processed by category in the third terminal detecting unit and the first server storage unit, and then to analyze inventory of the warehouse using the collected data and a demand prediction model of the deep learning solution stored in the third terminal storage unit.

7. The cloud-based artificial intelligence learning logistics management system of claim 6, wherein the display unit transfers data to the operator through an augmented reality interface by means of a transmissive display using organic light emitting diodes (OLEDs).

8. The cloud-based artificial intelligence learning logistics management system of claim 1, wherein the cloud-based artificial intelligence learning logistics management system forms a distributed cloud that transmits the deep learning solution, generated by the self-learning unit, to the autonomous transfer robot terminal, the operator terminal, and the warehouse management terminal so that processing is performed therein, and
wherein the communication network is any one communication network formed by combining one or more selected from the group consisting of an Internet, a Bluetooth network, a Wi-Fi network, and an Internet of Things (IoT).

9. The cloud-based artificial intelligence learning logistics management system of claim 1, wherein the deep learning solution includes a demand prediction model configured to predict a demand for warehouse products, a movement route optimization model for the autonomous transfer robot, and an operation optimization model for the operator that are generated through the self-learning unit by using autonomous transfer robot-generated data including an absolute location, route, motion, image, and sound of the autonomous transfer robot, operator-generated data including an absolute location, route, motion, image, and sound of the operator, unique product data including a producer, size, weight and quantity of the products in a warehouse, historical sales statistics of the products, product transportation data, surrounding event data, and demand data related to weather and temperature, which are data for learning refined through the first server collection unit, the first server analysis unit, the first server classification unit, and the first server storage unit.

10. A cloud-based artificial intelligence learning logistics management method comprising:
a data collection step of collecting, by a first server collection unit, data;
a data analysis step of analyzing availability of the data collected at the data collection step;
a data classification step of classifying the data, analyzed at the data analysis step, by category;
a data storage step of storing the data processed at the data processing step;
a data-for-learning collection step of collecting the data, stored at the data storage step, as data for learning;
a data-for-learning storage step of storing the data for learning collected at the data-for-learning collection step;
a self-learning step of generating a deep learning solution based on self-learning data and domain ontology provided from an outside by using the data stored at the data-for-learning storage step;
a deep learning solution storage step of storing the deep learning solution generated at the self-learning step;
a deep learning solution transmission step of transmitting the deep learning solution, stored at the deep learning solution storage step, to an autonomous transfer robot terminal, an operator terminal, and a warehouse management terminal; and
a deep learning solution-based processing step of performing logistics management by using the deep learning solution received by the autonomous transfer robot terminal, the operator terminal, and the warehouse management terminal.
